(19) United States
(12) Patent Application Publication
(10) Pub. No.: US 2008/0009156 A1
(43) Pub. Date: Jan. 10, 2008

(54) System and method for bonding coaxial cable

(76) Inventor: Glen K. Malin, Rye, NY (US)

Correspondence Address: BAKER BOTTS L.L.P., 30 ROCKEFELLER PLAZA, 44TH FLOOR, NEW YORK, NY, 10112-4498, US

(21) Appl. No.: 11/483,823

(22) Filed: Jul. 10, 2006

(51) Int. Cl. H01R 4/66

(52) U.S. Cl. 439/92

(57) ABSTRACT

The present invention provides a connector for bonding a coaxial cable to a ground wire. The connecter further connects two ends of coaxial drop cable such that the cable is spliced at the point of the connector. The connector secures ground wire by compression to assure reliability and prevent scoring or deforming the conductor. Furthermore, the connector can accommodate assorted sizes of ground wire.

### BACKGROUND OF INVENTION

The present invention relates to a system and method of bonding a coaxial drop cable to an existing grounding conductor, for example, in accordance with § 810.21 of the National Electric Code.

Installing drop cables at a particular location necessitates a grounding connection to the coaxial cable. Typically, this is accomplished by splicing the coaxial drop cable in conjunction with a ground block and bonding that ground block to an existing grounding electrode system by a ground wire mechanism. However, existing ground blocks feature an unreliable mechanism for capturing ground wire that may result in the ground wire dislodging or disconnecting from the grounding block which may reduce or preclude the grounding effect.

Traditional ground blocks utilize harsh mechanisms for securing the ground conductor. This often results in damage to the ground wire, which in turn impairs the function of the ground block system and increases the risk of electrification. It frequently occurs that the ground wire becomes scored or deformed by mechanisms designed to hold the ground wire in place at the point of grounding. Alternatively, traditional ground blocks may cause the ground wire to break. A need therefore exists for a grounding device that firmly secures the ground wire in order to allow for a superior ground connection without causing damage to the wire.

Additionally, known ground blocks are manufactured from steel, aluminum, or stainless steel. These metals are not as conductive as other types of metals in the brass/bronze family. Therefore, a need exists for the construction of a grounding device from an ideal grounding material such as silicon bronze.

Known ground blocks are cumbersome and aesthetically unpleasant. Traditional grounding systems often require mounting screws and elaborate connection devices. Furthermore, conventional ground blocks are not suitable for placement in tight confines such as utility boxes and underground pedestals. A need therefore exists for a grounding device that is small in size and simple in design.

### SUMMARY OF THE INVENTION

An object of the present invention is to overcome the disadvantages of the prior art by providing techniques for connecting spliced coaxial drop cable to an existing grounding conductor, for example, in accordance with § 810.21 of the National Electric Code.

In order to meet this and other objects of the present invention which will become apparent with reference to further disclosure set forth below, the present invention provides a connector for use in bonding coaxial cable with a common utility ground wire. In accordance with an exemplary embodiment of the present invention, the connector is adapted to attach directly to a ground wire using a gripping or compression mechanism. The connector is further adapted to bond a spliced coaxial drop cable. Since the connector of the present invention reduces the differential in electrical potentials between the grounding system and the coaxial drop cable, the risk of entry of electrical current in the interior wiring of a building is greatly reduced.

Additionally, in accordance with an exemplary embodiment of the present invention, the connector may bond to ground wire of different circumferences. The connector possesses two grooved sections that can accommodate different sizes of ground wire. For example and without limitation, the larger groove can accommodate a #6 AWG ground wire, and the smaller groove can accommodate a #12 or #14 AWG ground wire.

Furthermore, in accordance with an exemplary embodiment of the present invention, a ground wire is held firmly in the connector without scoring or deforming of the conductor. The present invention uses a clamping mechanism to firmly secure a ground wire without resultant damage to the wire. This prevents loss of electrical conductivity in the ground wire, thereby enhancing the efficiency of the grounding of the electrical current.

In accordance with an exemplary embodiment of the present invention, the connecting device is small in size and therefore can be easily manipulated by the installer. The small size of the connector dispenses with the need for mounting screws and is more aesthetically pleasing to users. The small size of the connector also facilitates placement of the device in tight confines such as utility lockboxes and network interface devices. Finally, due to its small size, the connector may be manufactured from silicon bronze or brass, which represent excellent conductive materials. The use of silicon bronze or brass prevents conflict between the various types of metal and improves electrical dissipation due to their enhanced electrical conduction relative to conventional ground block media. The construction thus ensures superior conductive properties and improved performance over conventional ground blocks.

The accompanying drawings, which are incorporated and constitute part of this disclosure, illustrate preferred embodiments of the invention and serve to explain the principles of the invention.

### BRIEF DESCRIPTION OF THE DRAWINGS

FIG. 1 is a diagram depicting a side view of a coaxial bonding connector, in accordance with an exemplary embodiment of the present invention;

FIG. 2 is a diagram depicting a side view of a coaxial bonding connector housing a single ground wire at the closed end of the connector, in accordance with an exemplary embodiment of the present invention;

FIG. 3 is a diagram depicting a side view of a coaxial bonding connector housing a single ground wire at the open end of the connector, in accordance with an exemplary embodiment of the present invention;

FIG. 4 is a diagram depicting a top view of a coaxial bonding connector, in accordance with an exemplary embodiment of the present invention;

FIG. 5 is a diagram depicting a bottom view of a coaxial bonding connector, in accordance with an exemplary embodiment of the present invention;

Throughout the figures, unless otherwise stated, the same reference numerals and characters are used to denote like features, elements, components, or portions of the illustrated embodiments.

### DETAILED DESCRIPTION OF THE INVENTION

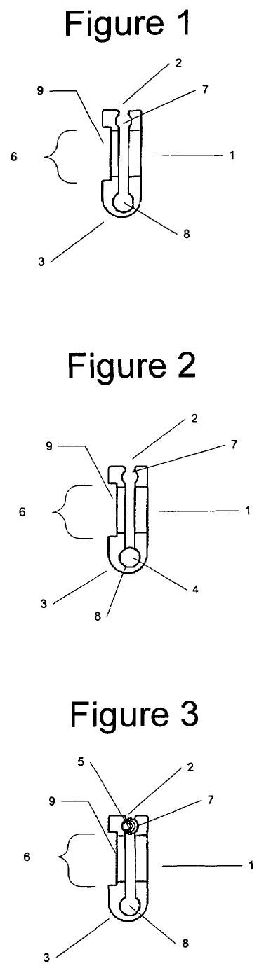

FIG. 1 depicts a side view of a coaxial bonding connector in which no ground wire is accommodated, in accordance with an exemplary embodiment of a the present invention.

A connector 1 is formed from a single strip of conducting material having a first end and a second end. The connector 1 is folded at approximately the midpoint of the strip such that the connector 1 assumes the shape of a clamp with an open end 2. In a preferred embodiment of the present invention, the length of the connector 1 may range from 0.75 to 1.25 inches (with a highly preferred embodiment having a length of 0.875), but may alternatively have any other length. In a preferred embodiment of the present invention, the width may range from 0.5 to 0.75 inches (with a highly preferred embodiment having a width of 0.532), but may alternatively have any other width. In a preferred embodiment of the present invention and without limitation, the depth of the connector 1, measured as the distance between the outer surfaces of the folded strip, may range from 0.125 to 0.5 inches, with a highly preferred embodiment having a distance between the outer surfaces of the folded strip of 0.312. The first and second ends of the connector 1 possess curved portions in proximity to the open end 2 of the connector 1, thereby forming a first circular furrow 7 which is adapted to receive a ground wire 5.

The connector 1 further includes a fold 3 opposite the open end 2, which may be shaped, for example, by straight edges, but which may alternatively have any other shape suitable for sustaining a fold. Cradled in the fold 3 is a second circular furrow 8 which is adapted to receive a ground wire 4. In a preferred embodiment of the present invention, the ground wire 4 received by the second circular furrow 8 is larger in diameter than the ground wire 5 received by the first circular furrow 7. In a preferred embodiment of the present invention, the distance between the first circular furrow 7 and the second circular furrow 8 may range from 0.25 to 1.0 inches (with a highly preferred embodiment having a distance between the first circular furrow 7 and the second circular furrow 8 of 0.665), but may alternatively have any other value.

A connector 1 further includes a receiving channel 6. The receiving channel 6 is adapted to accommodate a coaxial splice through the height of the connector 1. The receiving channel 6 is situated between the open end 2 and the fold 3 of the connector 1. In a preferred embodiment of the present invention and without limitation, the diameter of the receiving channel 6 may range from 0.350 to 0.4 inches, with a highly preferred embodiment having a diameter of 0.375.

As shown in FIG. 1, a connector 1 further includes a rectangular groove 9 on one surface of the connector 1. The rectangular groove 9 receives a hex-shaped portion of a splice 10 when the splice is inserted into the receiving channel 6. The hex-shaped portion of the splice 10 is fitted to the rectangular groove 9 such that insertion of the splice and situation of the hex-shaped portion in the rectangular groove 9 prevents the splice from traversing the entirety of the connector 1. Furthermore, receipt of the hex-shaped portion in the rectangular groove 9 of the connector 1 prevents the splice from turning when positioned in the connector 1. This ensures that the integrity of the conductivity is preserved when the connector 1 is used to bond spliced coaxial cable 12 and a ground wire 4,5. In a preferred embodiment of the present invention, the depth of the rectangular groove 9 may range from 0.02 to 0.10 inches, with a highly preferred embodiment having a depth of 0.066.

The connector 1 is manufactured from a material suitable for bonding a ground wire 4,5 and drop cable, and should have proper mechanical and electrical properties in order to ensure connection of the ground wire and drop cable and sufficient grounding thereof, as those skilled in the art will appreciate. Furthermore, the connector 1 should be able to firmly hold in place a ground wire 4,5 and the coaxial splice. Preferably, the connector 1 is formed from silicon bronze or brass, but may be comprised of any other comparable material, such as any of the yellow metals.

FIG. 2 depicts a side view of a coaxial bonding connector, in accordance with an exemplary embodiment of the present invention. The connector 1 is adapted to accommodate a ground wire 4 in a second circular furrow 8 that is located in the interior of the fold 3.

FIG. 3 is a diagram that depicts a side view of a coaxial bonding connector, in accordance with an exemplary embodiment of the present invention. The connector 1 is adapted to accommodate a ground wire 5 in a first circular furrow 7 that is located in proximity to the open end 2 of the connector 1.

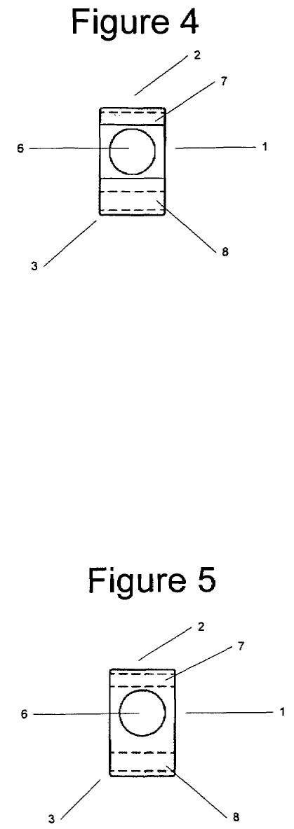

FIGS. 4 and 5 are diagrams that depict the top and bottom surfaces, respectively, of a coaxial bonding connector, in accordance with an exemplary embodiment of the present invention. The receiving channel 6 is positioned in the connector 1 such that there is no interference between a ground wire 4,5 and the coaxial splice when it is inserted into the receiving channel 6 and secured by the rectangular groove 9.

The receiving channel 6 allows for receipt of a coaxial splice 10, as shown in FIG. 1, which is positioned perpendicular to the surface of the connector 1. The splice 10 traverses the thickness of the connector 1, and portions of the splice extend outward from the connector 1 following insertion. Following insertion of the splice, a washer 14 and nut 16 combination are secured on the splice 10 adjacent to one exterior surface of the connector and opposite the side housing the rectangular groove 9. Application and tightening of the washer 14 and nut 16 combination causes compression of the connector 1 and thereby secures the ground wire 4,5 in the connector 1. A spliced coaxial cable 12 may then be threaded onto either end of the coaxial splice in such a manner as to secure a coaxial drop cable to the connector 1.

The connector 1 thus serves as a bonding device for a ground wire 4,5 and the coaxial cable. The coaxial cable is threaded onto a splice such that it is situated perpendicular to the single accommodated ground wire 4,5, which is secured by compression in the connector 1. The position of the coaxial drop cable against the connector 1 ensures that the open end 2 remains closed and that the ground wire 4,5 does not accidentally become dislodged from the connector 1 during use. The first circular furrow 7 and/or the second circular furrow 8 firmly hold the ground wire 4,5 in place without scoring or otherwise deforming the ground wire 4,5.

The foregoing merely illustrates the principles of the invention. Various modifications and alterations to the described embodiments will be apparent to those skilled in the art in view of the teachings herein. It will thus be appreciated that those skilled in the art will be able to devise numerous techniques which, although not explicitly described herein, embody the principles of the invention and are thus within the spirit and scope of the invention.

1. A drop grounding clamp for coupling a coaxial cable to a ground wire, comprising:
a single strip of conducting material having first and second ends and having a folded region approximately midway therein to form a clamp with one open side;
wherein said strip further includes a first curved region in proximity to said open side to form a circular receiving area that is adapted to receive a first ground wire therein;
wherein said strip further includes a second curved region at said folded region located opposite said open side that is adapted to receive a second ground wire therein; and
wherein said strip further includes a receiving channel for receiving a conducting coaxial splice for connecting to said coaxial cable, and said coaxial splice is adapted to compress said strip for securing said first and second ground wires to said respective first and second curved regions.

2. (canceled)

3. A drop grounding clamp as recited in claim 1, wherein said receiving channel is situated between said folded region and said open side of said strip.

4. A drop grounding clamp as recited in claim 1, wherein said strip has a rectangular groove therein for receiving and securing said coaxial splice.

5. A drop grounding clamp as recited in claim 1, wherein said strip comprises high strength silicon bronze or brass.

6-12. (canceled)

13. A method of coupling a coaxial cable and a ground wire using a folded strip of conducting material having first and second curved regions and a receiving channel, comprising the steps of:
inserting a first ground wire into said first curved region;
inserting a second ground wire into said second curved region;
inserting a conducting coaxial splice into said receiving channel; and
securing said first and second ground wires to said respective first and second curved regions by compressing said strip using said conducting coaxial splice.

14. A method as recited in claim 13, further comprising the step of attaching said coaxial cable to said coaxial splice.
